(19) United States
(12) Patent Application Publication
(10) Pub. No.: US 2012/0272534 A1
(43) Pub. Date: Nov. 1, 2012

(54) Knife With Carabiner

(76) Inventor: Anthony Lee, Los Angeles, CA (US)

(21) Appl. No.: 13/457,839

(22) Filed: Apr. 27, 2012

Related U.S. Application Data
(60) Provisional application No. 61/480,940, filed on Apr. 29, 2011.

(51) Int. Cl. B26B 1/02

(52) U.S. Cl. 30/298.4

(57) ABSTRACT

A knife is disclosed. The knife comprises a handle having carabiner loop integrally formed with an arm extending from one end of the handle and a gate extending from a second end, the gate pivotally attached to the handle whereby the carabiner loop can be opened or closed.

### CROSS-REFERENCE TO RELATED APPLICATIONS

This application claims benefit of U.S. Provisional Patent Application Ser. No. 61/480,940 (Atty. Dkt. No. OTI/0050USL), filed Apr. 29, 2011, which is herein incorporated by reference in its entirety.

### BACKGROUND OF THE INVENTION

1. Field of the Invention

Embodiments of the present invention generally relate to hand tools, and more specifically to a knife having an integral carabiner.

2. Description of the Related Art

A carabiner knife is disclosed in U.S. Pat. No. 6,223,372 and that patent is incorporated by reference herein in its entirety. The '372 patent includes a loop portion having a first arm member extending from a first end of the handle, a second arm member extending from a second end of the handle, and a gate connecting the arm members.

### SUMMARY OF THE INVENTION

A knife is disclosed. The knife comprises a handle having carabiner loop integrally formed with an arm extending from one end of the handle and a gate extending from a second end, the gate pivotally attached to the handle whereby the carabiner loop can be opened or closed.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side view of a carabiner knife with a blade in an operative position.

FIG. 2 is a side view of the carabiner knife with the blade in a closed position.

FIG. 3 is a side view of the carabiner knife with the blade in the closed position.

FIG. 4 is a side view of the carabiner knife with a gate in an open position.

FIG. 5 is a perspective view of the carabiner knife with the blade in the open position.

FIG. 6 is a perspective view of the carabiner knife with the blade in the closed position.

FIG. 7 is an end view of the carabiner knife with the blade in the operative position.

### DETAILED DESCRIPTION

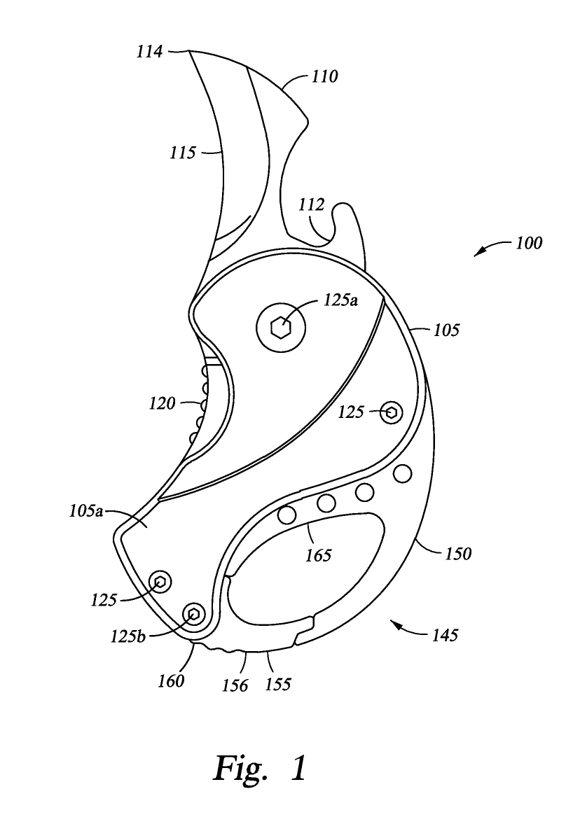

Referring specifically to FIG. 1, a carabiner knife in accordance with one embodiment of the present invention is generally designated by reference numeral 100.

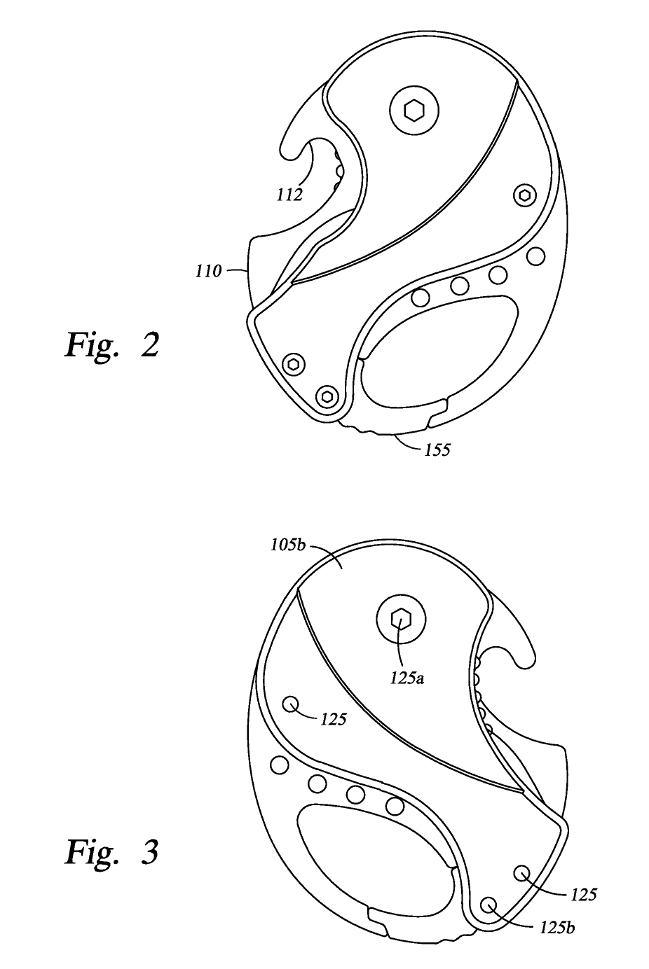

FIG. 1 is a side view of the carabiner knife 100. The carabiner knife 100 includes a handle 105 and a blade 110. The handle 105 is comprised of a right handle side 105a and a left handle side 105b. In a preferred embodiment, the handle may have curved edges, which, together with a carabiner loop 145 disposed on one side of the handle and the retractable blade 110 on the other side, form an overall oval shape, as can be seen in FIG. 2. The handle sides 105a, 105b may include textured surfaces to improve a user's grip. The handle sides 105a, 105b may be made of anodized aluminum.

The sides 105a, 105b are attached together by attachment members 125, 125a and 125b, which are secured in place with threaded arrangements. As can be seen in FIG. 2 and FIG. 3 (showing opposite sides of the knife 100), the attachment member 125a may actually be comprised of two inter-threaded attachment members. Attachment member 125a also provides for pivoting movement of the blade 110 with respect to the handle 105. Attachment member 125b also provides for pivoting movement of gate 155 about hinge 160 with respect to the handle 105, as discussed further below.

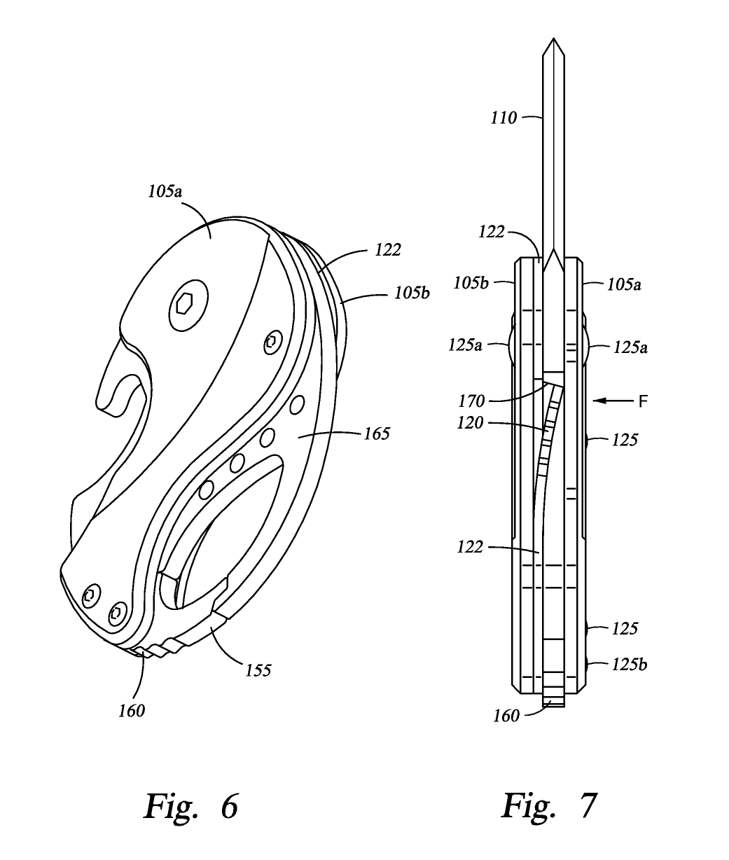

The blade 110 is manually moveable from a retracted position, as shown in FIGS. 2-6, to an open, operative position, as shown in FIG. 1. A blade lock 120 (FIG. 1) releasably locks the blade 110 in the operative position. In one embodiment, the blade lock 120 includes a liner-lock mechanism, which is known in the art. As can be seen in FIGS. 5 and 6, a blade lock base 122 is disposed between handle sides 105a, 105b and provides the necessary space within the handle 105 for the blade lock 120. The blade lock 120 may be comprised of a leaf spring integrally formed with blade lock base 122. When the blade 110 is in the open position, the blade lock 120 engages a canted surface 170 (shown in FIG. 7) on the end of the blade 110 opposite a point 114. When the blade lock 120 is engaged with the blade 110, the blade 110 is locked in the open position and prevented from pivoting to the closed position. To unlock the blade, a user overcomes the biasing force of the blade lock 120 by applying a lateral force F to the blade lock 120 (shown in FIG. 7), causing the blade lock 120 to disengage from blade 110. The force F may be applied with the user's thumb on the hand that is holding the carabiner knife 100. The blade 110 can then be pivotally moved to the closed position. Other locking mechanisms for releasably locking the blade in the operative position and/or in the retracted position may be used.

The blade 110 may be a hook-style blade with a concave cutting edge 115, as illustrated in FIG. 1. The blade 110 also includes point 114. Point 114 is suitable for scoring applications, due to the concave curvature of cutting edge 115. Other blade styles may be used, including, for example, a sporting blade, a saw blade, a tanto blade, or a utility blade mounted to a blade holder. Each of these blade types is known in the art. The edge of the blade 110 opposite of the cutting edge 115 may include an opener 112. The opener 112 is arranged so that torque applied by a user to open, for example, a bottle, is opposite to torque applied by the user to pivot the blade from the retracted position. Preferably, the blade 110 may be made of stainless steel.

The carabiner loop 145, disposed on one side of the handle 105, includes loop arm 150, gate 155 and loop base 165. The loop arm 150 may be integrally formed with the loop base 165. With this arrangement, the carabiner loop 145 may be formed of only two pieces—the integrally formed loop base 165 with loop arm 150, and the gate 155—thereby increasing the overall strength of carabiner loop 145. A supporting portion of the loop base 165 is disposed between handle sides 105a, 105b, which are secured in place by attachment members 125.

The gate 155 pivots about hinge 160 and is secured between the handle sides 105a, 105b by attachment member 125b. In this manner, the gate 155 is directly attached to the handle 105 at hinge 160. Thus, a second loop arm connecting the gate 155 to the handle 105 is not needed. Moreover, the handle sides 105a, 105b cover the hinge 160, which helps protect the hinge 160 from being damaged. The gate 155 may include a gripping surface 156.

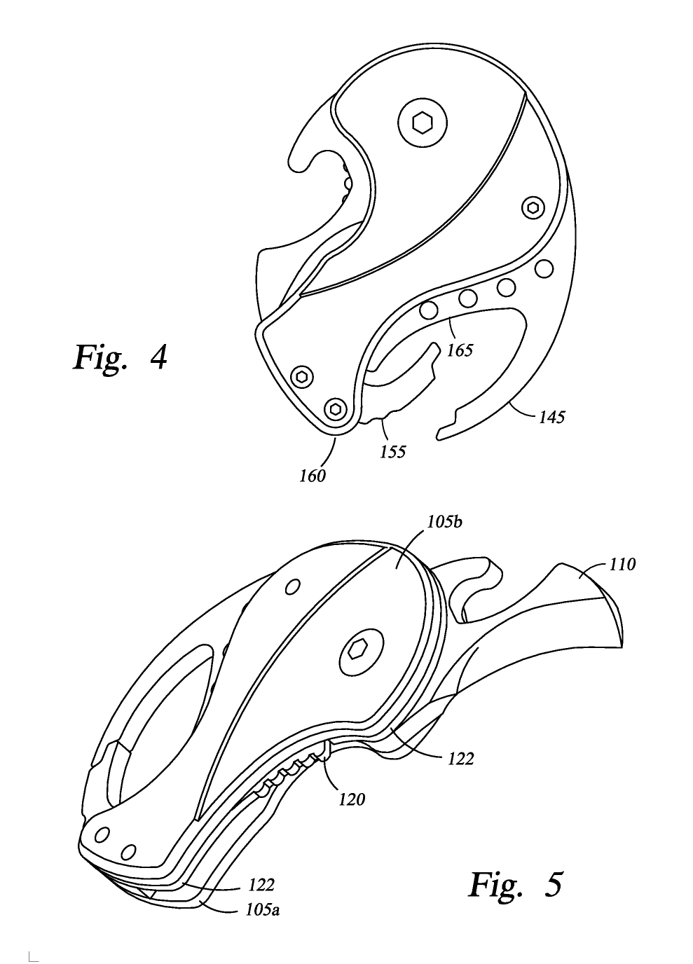

FIG. 2 shows the gate 155 in a closed position. FIG. 4 shows the gate 155 in an open position. A biasing member, such as a leaf spring or other suitable mechanism (not shown) provides a biasing force to urge the gate 155 into the closed position.

FIGS. 5 and 6 show perspective views of the knife 100. The arrangement between handle side 105a, blade 110, blade lock 120, blade lock base 122, and handle side 105b can be seen in FIG. 5. The arrangement between handle side 105a, loop base 165, gate 155, and handle side 105b can be seen in FIG. 6.

While the foregoing is directed to embodiments of the present invention, other and further embodiments of the invention may be devised without departing from the basic scope thereof, and the scope thereof is determined by the claims that follow.

1. A knife comprising:
a handle having a first side and a second side;
a blade constructed and arranged to be at least partially housed in and extend from the handle in an operative position; and
a carabiner loop integrally formed with the handle, the loop including an arm extending from the handle and a gate pivotally attached to the handle, the gate pivotable relative to the handle.
